(19) United States
(12) Patent Application Publication
(10) Pub. No.: US 2024/0298266 A1
(43) Pub. Date: Sep. 5, 2024

(54) COMMUNICATION DEVICE AND METHOD FOR HANDLING A BUS BANDWIDTH

(71) Applicant: Realtek Semiconductor Corp., HsinChu (TW)

(72) Inventor: Ying-Jen Yen, HsinChu (TW)

(73) Assignee: Realtek Semiconductor Corp., HsinChu (TW)

(21) Appl. No.: 18/581,349

(22) Filed: Feb. 19, 2024

(30) Foreign Application Priority Data
Mar. 3, 2023 (TW) 112107813

(51) Int. Cl. H04W 52/02; H04L 12/40

(52) U.S. Cl. CPC H04W 52/0261; H04L 12/4013

(57) ABSTRACT

A communication device includes a determination module for determining a first traffic threshold and a second traffic threshold, wherein the first traffic threshold is greater than the second traffic threshold; a comparison module, coupled to the determination module, for comparing a current traffic, the first traffic threshold and the second traffic threshold to generate a comparison result; and an adjustment module, coupled to the comparison module, for adjusting a first bus bandwidth to a second bus bandwidth according to the comparison result.

### BACKGROUND OF THE INVENTION

### 1. Field of the Invention

The present invention relates to a communication device and a method used in a wireless communication system, and more particularly, to a communication device and a method for handling a bus bandwidth.

### 2. Description of the Prior Art

In a wireless communication system, a bus bandwidth used by a communication device will increase as user demands increase. Although an increased bus bandwidth may achieve a better performance, such as a higher throughput, more power will be consumed. The communication device needs a large amount of power to operate, when a large bus bandwidth is continuously used. Thus, how to balance the issues of performance and power saving is an important problem to be solved.

### SUMMARY OF THE INVENTION

The present invention provides a communication device and a method to solve the abovementioned problem.

A communication device comprises: a determination module for determining a first traffic threshold and a second traffic threshold, wherein the first traffic threshold is greater than the second traffic threshold; a comparison module, coupled to the determination module, for comparing a current traffic, the first traffic threshold and the second traffic threshold to generate a comparison result; and an adjustment module, coupled to the comparison module, for adjusting a first bus bandwidth to a second bus bandwidth according to the comparison result.

A method for handling a bus bandwidth comprises: determining that a first traffic threshold and a second traffic threshold, wherein the first traffic threshold is greater than the second traffic threshold; comparing a current traffic, the first traffic threshold and the second traffic threshold to generate a comparison result; and adjusting a first bus bandwidth to a second bus bandwidth according to the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a communication system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

FIG. 5 is a flowchart of a process according to an example of the present invention.

FIG. 6 is a flowchart of a process according to an example of the present invention.

FIG. 7 is a schematic diagram of a scenario according to an example of the present invention.

### DETAILED DESCRIPTION

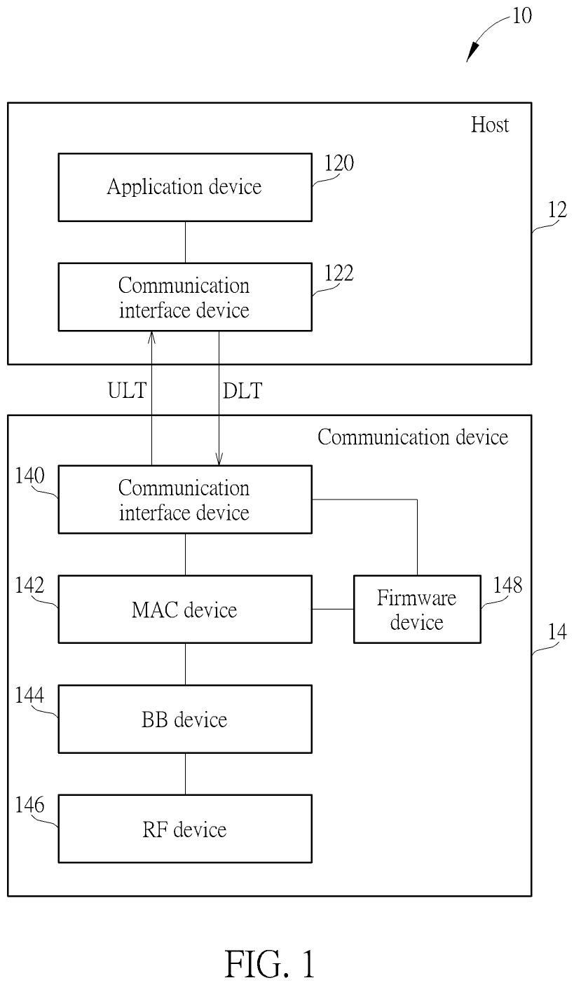

FIG. 1 is a schematic diagram of a communication system 10 according to an example of the present invention. The communication system 10 may be any communication system using an orthogonal frequency-division multiplexing (OFDM) technique (also termed as a discrete multi-tone modulation (DMT) technique), and is composed of a host 12 and a communication device 14. The communication system 10 may be any wired communication system such as an asymmetric digital subscriber line (ADSL) system, a power line communication (PLC) system or an Ethernet over coax (EOC), but is not limited herein. The communication system 10 may alternatively be any wireless communication system such as a wireless local area network (WLAN), a Digital Video Broadcasting (DVB) system, a Long Term Evolution (LTE) system, a Long Term Evolution-advanced (LTE-A) system or a fifth generation (5G) system, but is not limited herein. In addition, the host 12 and the communication device 14 may be installed in a mobile phone, a laptop, etc., but not limited herein. In one example, the host 12 may be a root complex (RC) device, but is not limited herein. In one example, the communication device 14 may be an end point, but is not limited herein.

In FIG. 1, the host 12 may comprise an application device 120 and a communication interface device 122. The application device 120 is configured for converting data to interface type data in order to make the data easy to read and access. The communication interface device 122 is coupled to the application device 120, and is configured for communicating with the communication device 14 to perform an uplink (UL) transmission ULT and a downlink (DL) transmission DLT (e.g., transmit and receive signals, data, messages and/or packets). In one example, the application device 120 may comprise a screen layout and/or a graphical user interface (GUI), but is not limited herein. In one example, the communication interface device 122 may be a RC peripheral component interconnect express (PCIe) interface, but is not limited herein.

In FIG. 1, the communication device 14 may comprise a communication interface device 140 (e.g., end point PCIe interface), a medium access control (MAC) device 142, a baseband (BB) device 144, a radio frequency (RF) device 146 and a firmware device 148. In detail, the communication interface device 140 is configured for communicating with the host 12 to perform the UL transmission ULT and the DL transmission DLT (e.g., transmit and receive signals, data, messages and/or packets). The MAC device 142 is coupled to the communication interface device 140, and is configured for processing communication protocol(s). Through the communication interface device 140, the communication device 14 may communicate (e.g., transmit and/or receive) protocol content processed by the MAC device 142 with the host 12. The BB device 144 is coupled to the MAC device 142, and is configured for managing antenna and RF related service, e.g., modulating and demodulating signals, according to the protocol content processed by the MAC device 142. The RF device 146 is coupled to the BB device 144, and is configured for converting the signals modulated by the BB device 144 to RF signals. The firmware device 148 is coupled to the communication interface device 140 and the MAC device 142, and is configured for assisting the communication interface device 140 and the MAC device 142 in performing communication operations.

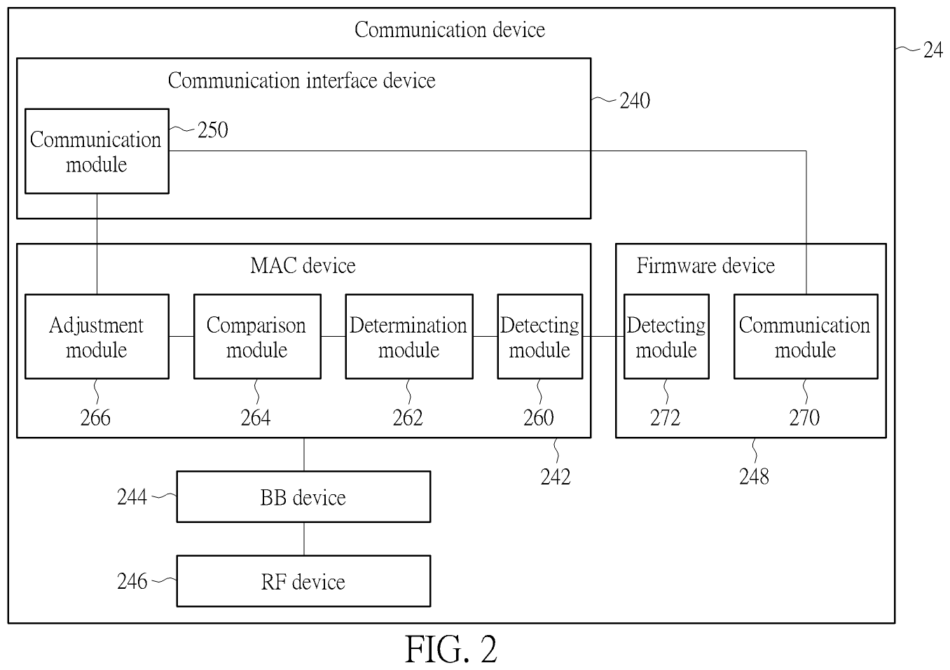

FIG. 2 is a schematic diagram of a communication device 24 according to an example of the present invention, and may be utilized to realize the communication device 14 of FIG. 1. The communication device 24 may be a wireless local-area network (WLAN) (e.g., Wi-Fi) device, but is not limited herein. The communication device 24 may comprise a communication interface device 240, a MAC device 242, a BB device 244, a RF device 246 and a firmware device 248, which may refer to the communication interface device 140, the MAC device 142, the BB device 144, the RF device 146 and the firmware device 148 of FIG. 1, respectively, and are not narrated herein. The communication interface device 240 may comprise a communication module 250. The MAC device 242 may comprise a detecting module 260, a determination module 262, a comparison module 264 and an adjustment module 266. The firmware device 248 may comprise a communication module 270 and a detecting module 272.

In FIG. 2, the determination module 262 is configured for determining a first traffic threshold and a second traffic threshold, wherein the first traffic threshold is greater than the second traffic threshold. The comparison module 264 is coupled to the determination module 262, and is configured for comparing a current traffic, the first traffic threshold and the second traffic threshold to generate a comparison result. The adjustment module 266 is coupled to the comparison module 264, and is configured for adjusting a first bus bandwidth to a second bus bandwidth according to the comparison result. The detecting module 260 is coupled to the determination module 262. In one example, the detecting module 260 is configured for detecting a current application scenario according to at least one packet in the current traffic. In one example, the detecting module 260 is configured for detecting a link speed. The communication module 250 is coupled to the adjustment module 266, and is configured for performing a handshake with a host (e.g., the host 12 of FIG. 1) to notify the host of the second bus bandwidth. That is, by performing the handshake with the host, the communication device 24 adjusts (e.g., downgrades or upgrades) the bus bandwidth. The communication module 270 is coupled to the communication module 250, and is configured for assisting the communication module 250 in performing the handshake. The detecting module 272 is coupled to the detecting module 260, and is configured for assisting the detecting module 260 in detecting the current application scenario and/or the link speed.

In one example, the determination module 262 determines the first traffic threshold and the second traffic threshold according to the current application scenario. In one example, the current application scenario comprises at least one of a heavy loading mode, a light loading mode and a power saving mode. The heavy loading mode may comprise at least one of a download file mode and a video viewing mode, but is not limited herein. The light loading mode may comprise a web browsing mode, but is not limited herein. The power saving mode may comprise at least one of a radio off mode, an airplane mode, a low power mode, a wake on wireless local area network (WoWLAN) mode and a modern standby mode, but is not limited herein. The low power mode may comprise at least one of an un-associated idle mode, an associated idle mode and a disable mode (e.g., the communication device state is D3). In one example, the adjustment module 266 adjusts the first bus bandwidth to a minimum bus bandwidth, when the current application scenario is the power saving mode (i.e., the communication device enters the power saving mode). For example, the adjustment module 266 downgrades the link speed to PCIe Generation 1 (hereinafter “Gen 1”), and reduces a lane number to 1 or 2 (1-lane/2-lane). In one example, the determination module 262 determines the first traffic threshold and the second traffic threshold according to the link speed and the lane number.

In one example, the link speed may be Gen 1, Gen 2, Gen 3 and Gen 4, but is not limited herein. In one example, the link speed is determined according to at least one of a maximum link speed, a supported link speed and a target link speed. The maximum link speed may be stored (e.g., defined) in a PCIe Link Capabilities Register. The supported link speed may be stored (e.g., defined) in a PCIe Link Capabilities 2 Register. The target link speed may be stored (e.g., defined) in a PCIe Link Control 2 Register. In one example, the lane number may be 1, 2, 4, 8 or 16, but is not limited herein. In one example, the lane number is determined according to a maximum lane number. The maximum lane number may be stored (e.g., defined) in a PCIe Link Capabilities Register.

In one example, the adjustment module 266 determines that the second bus bandwidth is smaller than the first bus bandwidth (i.e., downgrades the bus bandwidth), when the current traffic is smaller than the second traffic threshold. In one example, the adjustment module 266 determines that the second bus bandwidth is equal to the first bus bandwidth (i.e., maintains the bus bandwidth), when the current traffic is not smaller than the second traffic threshold and the current traffic is smaller than the first traffic threshold. In one example, the adjustment module 266 determines that the second bus bandwidth is greater than the first bus bandwidth (i.e., upgrades the bus bandwidth), when the current traffic is not smaller than the first traffic threshold. That is, the bus bandwidth may be adjusted dynamically according to the current traffic, the first traffic threshold and the second traffic threshold.

In one example, the detecting module 260 detects the current application scenario by identifying at least one field of at least one packet. In one example, the detecting module 260 detects at least one priority of the at least one packet by identifying the at least one field of the at least one packet. The adjustment module 266 adjusts the first bus bandwidth to the second bus bandwidth according to the at least one priority of the at least one packet. In one example, the step for the adjustment module 266 to adjust the first bus bandwidth comprises at least one following step: adjusting the link speed; and adjusting the lane number.

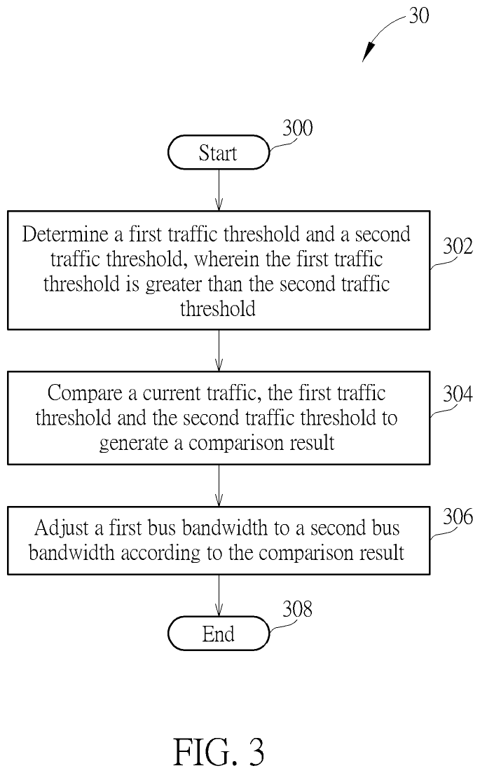

Operations of the communication device 24 in the above examples can be summarized into a process 30 shown in FIG. 3 and utilized in the communication device 14 of FIG. 1. The process 30 includes the following steps:

Step 300: Start.

Step 302: Determine a first traffic threshold and a second traffic threshold, wherein the first traffic threshold is greater than the second traffic threshold.

Step 304: Compare a current traffic, the first traffic threshold and the second traffic threshold to generate a comparison result.

Step 306: Adjust a first bus bandwidth to a second bus bandwidth according to the comparison result.

Step 308: End.

A detailed description and variations of the process 30 can be known by referring to the above description, and are not narrated herein.

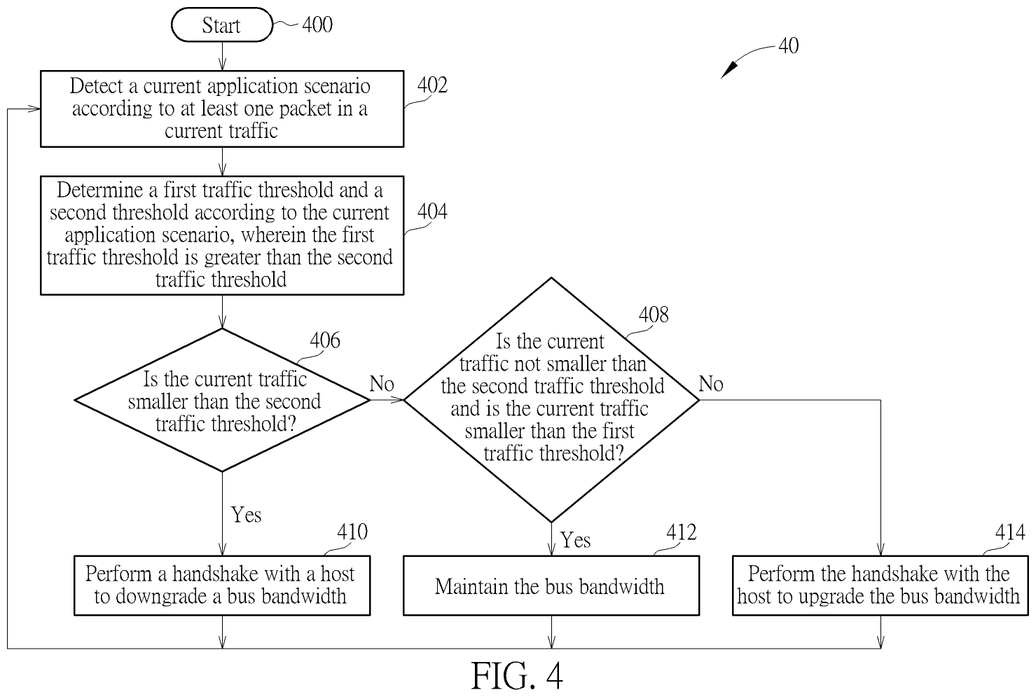

FIG. 4 is a flowchart of a process 40 according to an example of the present invention, and may be utilized in a communication device (e.g., the communication device 14 of FIG. 1 or the communication device 24 of FIG. 2). The process 40 includes the following steps:

Step 400: Start.

Step 402: Detect a current application scenario according to at least one packet in a current traffic.

Step 404: Determine a first traffic threshold and a second threshold according to the current application scenario, wherein the first traffic threshold is greater than the second traffic threshold.

Step 406: Is the current traffic smaller than the second traffic threshold? If yes, perform Step 410; otherwise, perform Step 408.

Step 408: Is the current traffic not smaller than the second traffic threshold and is the current traffic smaller than the first traffic threshold? If both are true, perform Step 412; otherwise, perform Step 414.

Step 410: Perform a handshake with a host to downgrade a bus bandwidth, and perform Step 402.

Step 412: Maintain the bus bandwidth, and perform Step 402.

Step 414: Perform the handshake to upgrade the bus bandwidth, and perform Step 402.

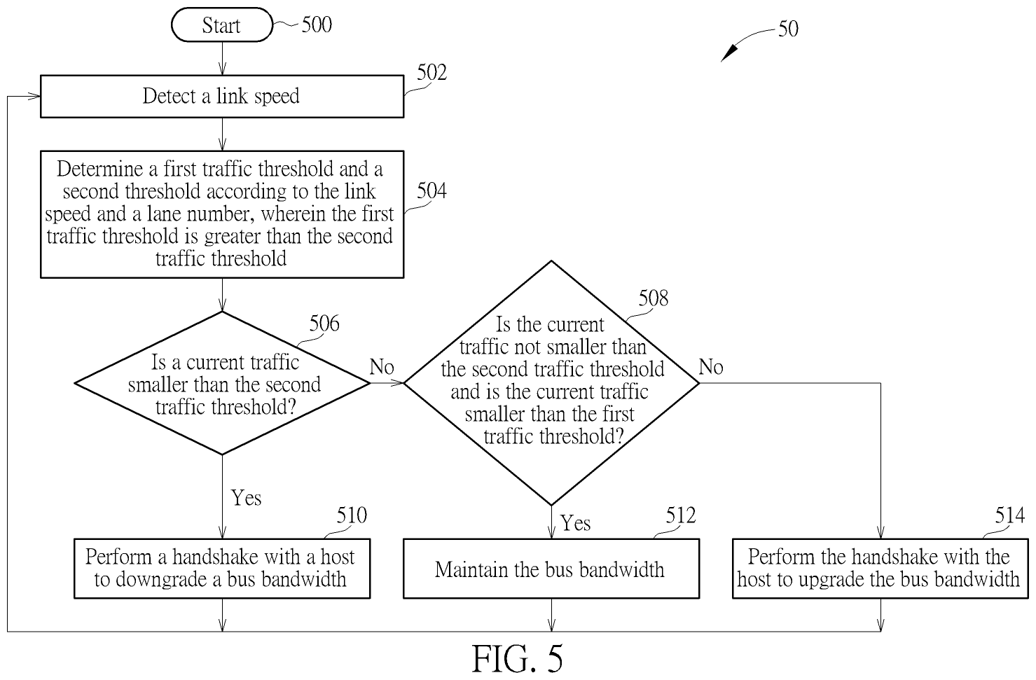

FIG. 5 is a flowchart of a process 50 according to an example of the present invention, and may be utilized in a communication device (e.g., the communication device 14 of FIG. 1 or the communication device 24 of FIG. 2). The process 50 includes the following steps:

Step 500: Start.

Step 502: Detect a link speed.

Step 504: Determine a first traffic threshold and a second threshold according to the link speed and a lane number, wherein the first traffic threshold is greater than the second traffic threshold.

Step 506: Is a current traffic smaller than the second traffic threshold? If yes, perform Step 510; otherwise, perform Step 508.

Step 508: Is the current traffic not smaller than the second traffic threshold and is the current traffic smaller than the first traffic threshold? If both are true, perform Step 512; otherwise, perform Step 514.

Step 510: Perform a handshake with a host to downgrade a bus bandwidth, and perform Step 502.

Step 512: Maintain the bus bandwidth, and perform Step 502.

Step 514: Perform the handshake to upgrade the bus bandwidth, and perform Step 502.

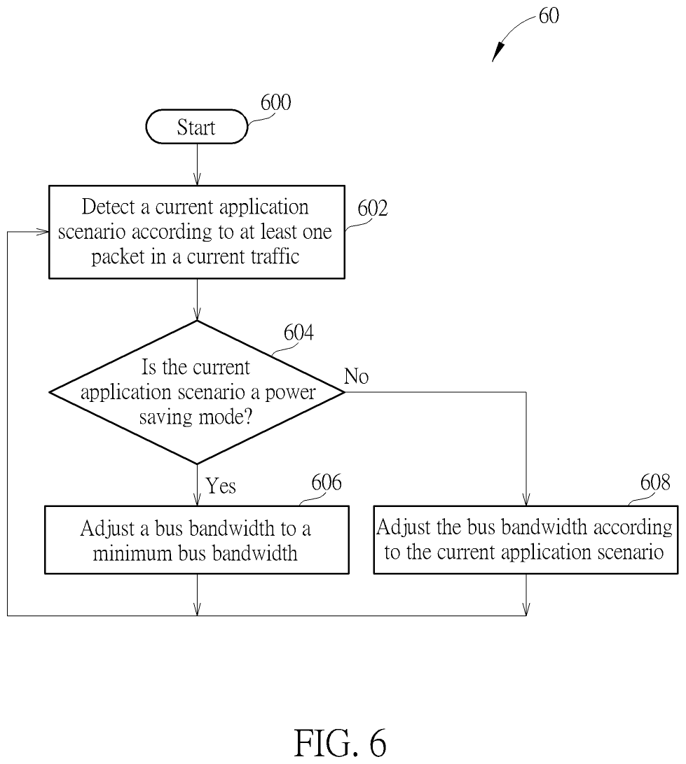

FIG. 6 is a flowchart of a process 60 according to an example of the present invention, and may be utilized in a communication device (e.g., the communication device 14 of FIG. 1 or the communication device 24 of FIG. 2). The process 60 includes the following steps:

Step 600: Start.

Step 602: Detect a current application scenario according to at least one packet in a current traffic.

Step 604: Is the current application scenario a power saving mode? If yes, perform Step 606; otherwise, perform Step 608.

Step 606: Adjust a bus bandwidth to a minimum bus bandwidth, and perform Step 602.

Step 608: Adjust the bus bandwidth according to the current application scenario, and perform Step 602.

In the process 60, a detailed description of Step 608 can be known by referring to the processes 40-50 (e.g., Steps 404-414 and Steps 500-514), and is not narrated herein.

A detailed description and variations of the processes 40-60 can be known by referring to the previous description, and are not narrated herein. In one example, the processes 40-60 are terminated, when an event occurs (e.g., the communication device shuts down or crashes). That is, the communication device continuously performs detection to dynamically adjust the bus bandwidth, unless the event occurs.

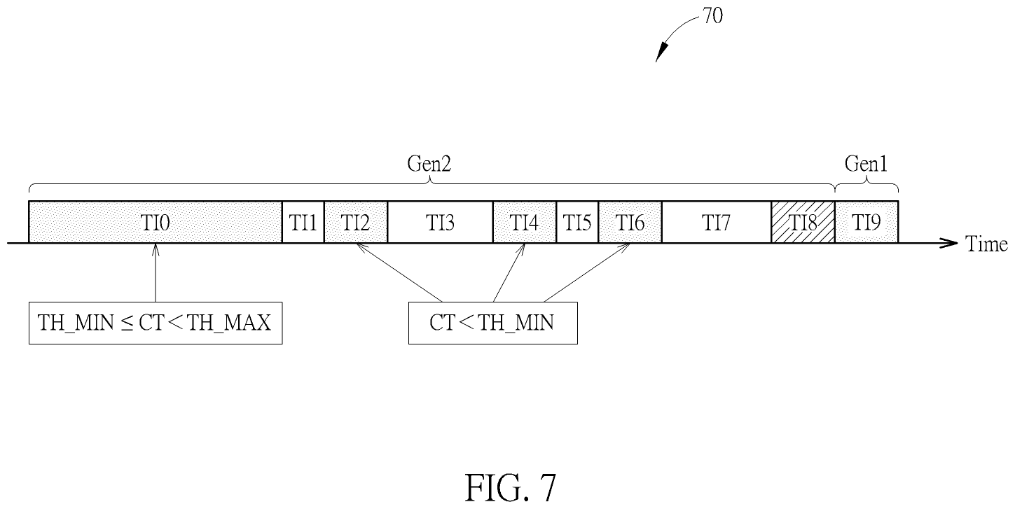

FIG. 7 is a schematic diagram of a scenario 70 according to an example of the present invention. FIG. 7 illustrates how a communication device (e.g., the communication device 14 of FIG. 1 or the communication device 24 of FIG. 2) adjusts a bus bandwidth when a lane number remains unchanged. In FIG. 7, the horizontal axis is a time domain, and time intervals TI0-TI9 are in the time domain. The communication device transmits packets (e.g., to a host such as the host 12 of FIG. 1) in the time intervals TI0, TI2, TI4, TI6 and TI9 (represented by dotted frames). The communication device enters an idle mode in the time intervals TI1, TI3, TI5 and TI7 (represented by blank frames). The communication device adjusts the bus bandwidth in the time interval TI8 (represented by a hatched frame). In detail, in the time intervals TI10, the communication device transmits packets at the link speed Gen 2, determines a maximum traffic threshold TH_MAX (e.g., the first traffic threshold mentioned above) and a minimum traffic threshold TH_MIN (e.g., the second traffic threshold mentioned above), and compares a current traffic CT, the maximum traffic threshold TH_MAX and the minimum traffic threshold TH_MIN. The communication device knows the current CT is not smaller than the minimum traffic threshold TH_MIN and the current CT is smaller than the maximum traffic threshold TH_MAX. Thus, the communication device maintains the bus bandwidth, i.e., maintains the link speed as Gen 2. In the time intervals TI2, TI4 and TI6, the communication device transmits packets at the link speed Gen 2, and knows the current CT is smaller than the minimum traffic threshold TH_MIN. Thus, in the time intervals TI8, the communication device performs a handshake with the host to downgrade the bus bandwidth, i.e., downgrade the link speed as Gen 1. Finally, in the time intervals TI9, the communication device transmits packets at the link speed Gen 1.

The terms “first” and “second” described above distinguish the related description, but do not limit the order of the related description. The term “according to” described above may be replaced by the term “via”, “by using” or “in response to”. The term “comprise” described above may be replaced by the term “is”.

It should be noted that there are various possible realizations of the communication device 24 (including the communication interface device 240, the MAC device 242, the BB device 244, the RF device 246 and the firmware device 248). For example, the devices mentioned above may be integrated into one or more devices/circuits. In addition, the communication device 24 and the devices in the communication device 24 may be realized by hardware (e.g., circuits), software, firmware (known as a combination of a hardware device, computer instructions and data that reside as read-only software on the hardware device), an electronic system or a combination of the devices mentioned above, but are not limited herein.

To sum up, the present invention provides a communication device and a method for handling a bus bandwidth. The communication device dynamically adjusts the bus bandwidth according to the usage of the communication device, such as the current application scenario, the packet priority, the link speed and/or the lane number, in order to take into account performance and power saving. In addition, when the communication device enters a power saving mode, the communication device dynamically adjusts the bus bandwidth to a minimum bus bandwidth in order to save power.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device, comprising:
a determination module, for determining a first traffic threshold and a second traffic threshold, wherein the first traffic threshold is greater than the second traffic threshold;
a comparison module, coupled to the determination module, for comparing a current traffic, the first traffic threshold and the second traffic threshold to generate a comparison result; and
an adjustment module, coupled to the comparison module, for adjusting a first bus bandwidth to a second bus bandwidth according to the comparison result.

2. The communication device of claim 1, further comprising:
a detecting module, coupled to the determination module, for detecting a current application scenario according to at least one packet in the current traffic.

3. The communication device of claim 2, wherein the determination module determines the first traffic threshold and the second traffic threshold according to the current application scenario.

4. The communication device of claim 2, wherein the current application scenario comprises at least one of a heavy loading mode, a light loading mode and a power saving mode.

5. The communication device of claim 4, wherein the power saving mode comprises at least one of a radio off mode, an airplane mode, a low power mode, a wake on wireless local area network (WoWLAN) mode and a modern standby mode.

6. The communication device of claim 4, wherein the adjustment module adjusts the first bus bandwidth to a minimum bus bandwidth, when the current application scenario is the power saving mode.

7. The communication device of claim 1, further comprising:
a detecting module, coupled to the determination module, for detecting a link speed.

8. The communication device of claim 7, wherein the determination module determines the first traffic threshold and the second traffic threshold according to the link speed and a lane number.

9. The communication device of claim 1, wherein the step of adjusting the first bus bandwidth to the second bus bandwidth according to the comparison result comprises:
determining that the second bus bandwidth is smaller than the first bus bandwidth, when the current traffic is smaller than the second traffic threshold;
determining that the second bus bandwidth is equal to the first bus bandwidth, when the current traffic is not smaller than the second traffic threshold and the current traffic is smaller than the first traffic threshold; and
determining that the second bus bandwidth is greater than the first bus bandwidth, when the current traffic is not smaller than the first traffic threshold.

10. The communication device of claim 1, further comprising:
a communication module, coupled to the adjustment module, for performing a handshake with a host to notify the host of the second bus bandwidth.

11. A method for handling a bus bandwidth, comprising:
determining a first traffic threshold and a second traffic threshold, wherein the first traffic threshold is greater than the second traffic threshold;
comparing a current traffic, the first traffic threshold and the second traffic threshold to generate a comparison result; and
adjusting a first bus bandwidth to a second bus bandwidth according to the comparison result.

12. The method of claim 11, further comprising:
detecting a current application scenario according to at least one packet in the current traffic.

13. The method of claim 12, wherein the first traffic threshold and the second traffic threshold are determined according to the current application scenario.

14. The method of claim 12, wherein the current application scenario comprises at least one of a heavy loading mode, a light loading mode and a power saving mode.

15. The method of claim 14, wherein the power saving mode comprises at least one of a radio off mode, an airplane mode, a low power mode, a wake on wireless local area network (WoWLAN) mode and a modern standby mode.

16. The method of claim 14, wherein the first bus bandwidth is adjusted to a minimum bus bandwidth, when the current application scenario is the power saving mode.

17. The method of claim 11, further comprising:
detecting a link speed.

18. The method of claim 17, wherein the first traffic threshold and the second traffic threshold are determined according to the link speed and a lane number.

19. The method of claim 11, wherein the step of adjusting the first bus bandwidth to the second bus bandwidth according to the comparison result comprises:
determining that the second bus bandwidth is smaller than the first bus bandwidth, when the current traffic is smaller than the second traffic threshold;
determining that the second bus bandwidth is equal to the first bus bandwidth, when the current traffic is not smaller than the second traffic threshold and the current traffic is smaller than the first traffic threshold; and
determining that the second bus bandwidth is greater than the first bus bandwidth, when the current traffic is not smaller than the first traffic threshold.

20. The method of claim 11, further comprising:
performing a handshake with a host to notify the host of the second bus bandwidth.
